(19) United States
(12) Patent Application Publication
(10) Pub. No.: US 2012/0005173 A1
(43) Pub. Date: Jan. 5, 2012

(54) DETERMINING EQUIVALENCE OF LARGE STATE REPOSITORIES UTILIZING THE COMPOSITION OF AN INJECTIVE FUNCTION AND A CRYPTOGRAPHIC HASH FUNCTION

(75) Inventor: Kevin A. Esler, Bedford, MA (US)

(73) Assignee: INTERNATIONAL BUSINESS MACHINES CORPORATION, ARMONK, NY (US)

(21) Appl. No.: 12/826,964

(22) Filed: Jun. 30, 2010

(51) Int. Cl. G06F 7/00; G06F 17/30

(52) U.S. Cl. 707/698; 707/797; 707/E17.032

(57) ABSTRACT

An injective function can execute against two different data repositories to generate a textual state representation for each of the different data repositories. The injective function can be a function that preserves distinctness, where the distinctiveness can be a one-to-one mapping of each element within the element domain to one element of a co-domain. The hash function can be executed for each of the different textual state representations to generate a corresponding hash number. The hash numbers can be compared to each other. When results from the comparing indicate the hash numbers are equivalent, the two different data repositories can be determined to be equivalent to each other and when results indicates the hash numbers are not equivalent, the two different data repositories can be determined to be not equivalent to each other.

### BACKGROUND

The present invention relates to the field of synchronization and, more particularly, to determining equivalence of large state repositories by composing an injective function and a cryptographic hash function.

In many large scale enterprise environments, several content repositories (e.g., file structure or database format) can exist throughout the enterprise infrastructure. These repositories can be large content data stores which can include mission critical data. In many instances, these repositories can be remotely located, such as geographically distant. Frequently, it is necessary for these repositories to be synchronized to maintain correct system behavior. In these instances, synchronization typically occurs over enterprise networks, which are frequently subject to intense utilization.

Traditional approaches to synchronization are time-consuming and can require tremendous infrastructure bandwidth. A common technique is to compare the entire contents of two (or more) different repositories. This can usually involve the entire contents of one or more repositories to be conveyed over a network which substantially tax already saturated networks. Once conveyed, an exhaustive node-by-node comparison must to be conducted. Again, significant computing resources are required for this approach to deliver results. For large repositories, this approach is very slow, and must be conducted in series, which can frequently result in bottleneck issues.

### SUMMARY

One aspect of the disclosure comprises of executing an injective function against two different data repositories to generate a textual state representation for each of the different data repositories. The injective function is a function that preserves distinctness, where the distinctiveness is a one-to-one mapping of each element within the element domain to one element of a co-domain. The hash function can be executed for each of the different textual state representations to generate a corresponding hash number. The hash numbers can be compared to each other. When results from the comparing indicate the hash numbers are equivalent, the two different data repositories can be determined to be equivalent to each other and when results indicates the hash numbers are not equivalent, the two different data repositories can be determined to be not equivalent to each other.

The disclosure can be implemented as a method, as a computer program product, as a device, and as a system, depending on implementation specifics. The computer program product can be stored in a non-transient, tangible storage medium. The computer program product can include computer usable or readable code that is executable by one or more processor. The computer program product can be implemented in software, firmware, or even hard-wired within electronic circuitry. The system can include a processor, a volatile memory, a non-volatile memory, a network transceiver, and other such components interconnected via a bus. The processor can execute the computer program product, which can be stored in the non-volatile or volatile memory.

### BRIEF DESCRIPTION OF THE SEVERAL VIEWS OF THE DRAWINGS

FIG. 1 is a schematic diagram illustrating a method for determining equivalence of large state repositories utilizing the composition of an injective function and a cryptographic hash function in accordance with an embodiment of the inventive arrangements disclosed herein.

FIG. 2 is a schematic diagram illustrating a system for determining equivalence of large state repositories utilizing the composition of an injective function and a cryptographic hash function in accordance with an embodiment of the inventive arrangements disclosed herein.

### DETAILED DESCRIPTION

The present invention discloses a solution for determining equivalence of large state repositories utilizing the composition of an injective function and a cryptographic hash function. In the solution, an injective function can execute to generate a textual state representation from each of the two different repositories, while preserving node distinctiveness regardless of repository specific formatting. In mathematics, an injective function is a function that preserves distinctness: it never maps distinct elements of its domain to the same element of its co-domain. Thus, if the different data repositories are the same, the generated textual state representations will be the same, else the generated text files will be different.

One aspect of the disclosure comprises of executing an injective function against two different data repositories to generate a textual state representation for each of the different data repositories. The injective function is a function that preserves distinctness of each element within the element domain. The distinctiveness is a one-to-one mapping of each element within the element domain to one element of a co-domain. The hash function can be executed for each of the different textual state representations to generate a corresponding hash number which can be smaller in size than the textual state representation to which it corresponds. The hash numbers can be compared to each other. When results from the comparing indicate the hash numbers are equivalent, the two different data repositories can be determined to be equivalent to each other. When results from the comparing indicate the hash numbers are not equivalent, the two different data repositories can be determined to be not equivalent to each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

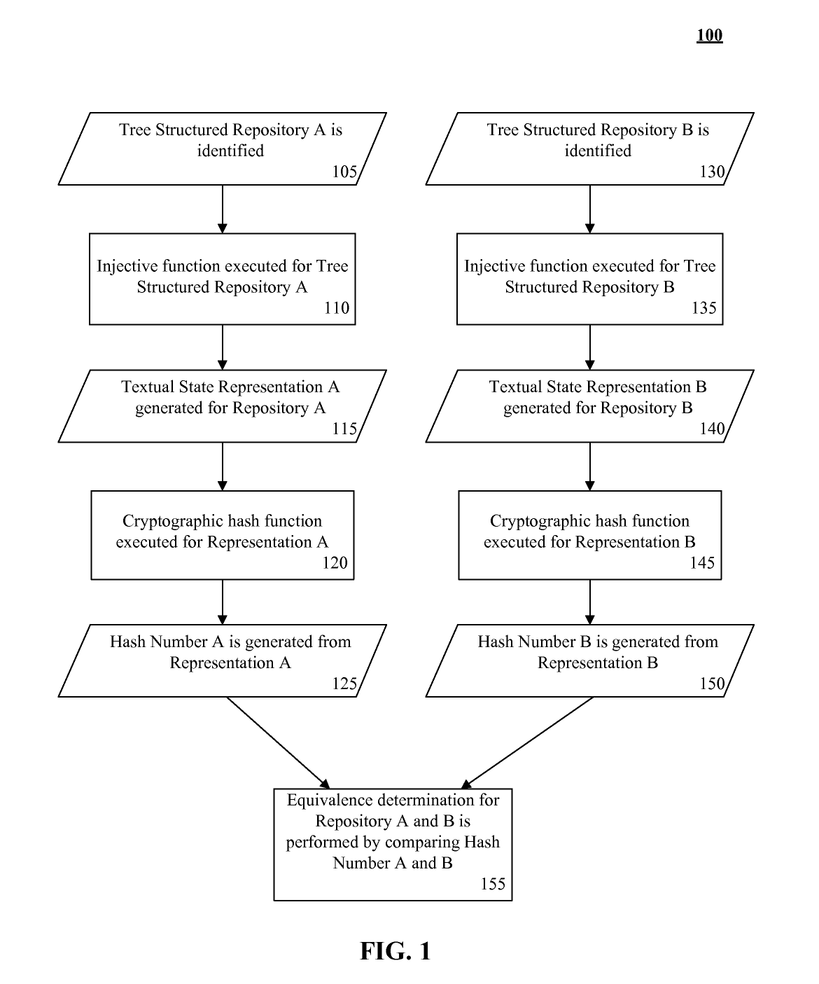

FIG. 1 is a schematic diagram illustrating a method 100 for determining equivalence of large state repositories utilizing the composition of an injective function and a cryptographic hash function in accordance with an embodiment of the inventive arrangements disclosed herein. In method 100, the equivalence of two or more repositories can be rapidly determined utilizing a textual representation of the repositories. The textual representation can be generated utilizing an injective function performed on each of the repositories. Once the textual representation is generated, a secure hash (e.g., cryptographic hash) can be computed for each repository. The two or more repositories can be deemed identical when two or more of the secure hashes are identical. When the hashes are different, the repositories can be considered not equivalent.

As used herein, repository can include, but is not limited to, tree structured repository, state repository, database, federated repository, and the like. It should be appreciated, the method is not limited to two repositories, but can be adapted to determine the equivalence of N repositories.

Method 100 can be performed intermittently and/or continuously depending on availability of computing resources. For instance, method 100 can be performed during “idle” time. Method 100 can be performed in response to an automatic and/or manual invocation. For example, method 100 can be enacted when a manual synchronization action is invoked within a software application. Further, it should be noted, steps 105-125 can be performed in simultaneously and/or in parallel with steps 130-150, enabling equivalence determination to be performed in manner free from traditional restrictions (e.g., serial operations). In one embodiment, steps 105-125, 130-150 can be performed in real-time and/or near real-time.

In step 105, a tree structured Repository A can be identified for equivalence determination. In step 110, an injective function can be performed on Repository A, which generates Textual State Representation A, as shown in step 115. Representation A can be a canonical text representation of Repository A. In step 120, a cryptographic hash function can be executed on Representation A to produce Hash Number A, shown by step 125. Hash Number A can be very much smaller than Representation A, such as being a thousand times smaller than Textual State Representation A.

In step 130, a tree structured Repository B can be identified. In step 135, an injective function can be performed on Repository B, which generates Textual State Representation B, as shown in step 140. Representation B can be a canonical text representation of Repository B. In step 145, a cryptographic hash function can be executed on Representation B to produce Hash Number B, shown by step 150. Hash Number B can be very much smaller than Representation B, such as being a thousand times smaller than Textual State Representation B.

In step 155, equivalence determination can be performed. The determination can include, but is not limited to, a comparison operation of Hash A and Hash B can be executed. Comparison operation can include bitwise comparison, byte-wise comparison, matrix comparison, and the like. Depending on the result of the comparison operation, an appropriate action can be performed. In one instance, the comparison operation can trigger a user interface dialog to be presented indicating the result of the comparison operation. In the instance, the result can include a summary and/or detailed description of the equivalence determination. For example, a graphical user interface (GUI) dialog (e.g., IBM CLEARCASE Web view) can be presented indicating whether Repository A and B are equivalent. In another instance, the comparison operation can trigger a synchronization functionality. In the instance, the synchronization functionality can attempt to synchronize repositories which are not equivalent based on one or more established settings.

It should be noted that steps 130-150 can execute independent of steps 105-125. For example, Steps 130-150 can execute concurrent with, before, or after steps 105-125 are executed. Further, steps 130-150 can execute within a different device (or the same device) as that which executes steps 105-125. Steps 130-150 are substantially equivalent to steps 105-125, except they are conducted for a different repository (Tree Structured Repository B), representation (Textual State Representation B), and hash number (Hash Number B).

Any number (0 . . . N) of additional repositories (repositories C, D, E, F, . . . ) can be compared by executing substantially equivalent steps for each repository, then comparing the corresponding hash numbers, as shown in method 100. For simplicity of expression, two repositories (Repository A and Repository B) are shown, which is not a limitation of the disclosure.

It should be further noted that the possibility of two or more hash numbers being equivalent without corresponding textual state representations being equivalent is extremely remote and statistically negligible. Since an injective function is used, the possibility of the textual state representations being equivalent without corresponding data repositories being equivalent is nil.

The method 100 can represent a ten to a thousand fold increase or more over traditional techniques for repository equivalence determination. The efficiency can geometrically increase as the number of repository being compared increases, which can result in tremendous gains when large numbers of repositories are being synchronized with each other. For instance, Web based synchronization situations involving a relatively large set of users associated with peer-to-peer file/folder synchronizations can benefit significantly from the method 100.

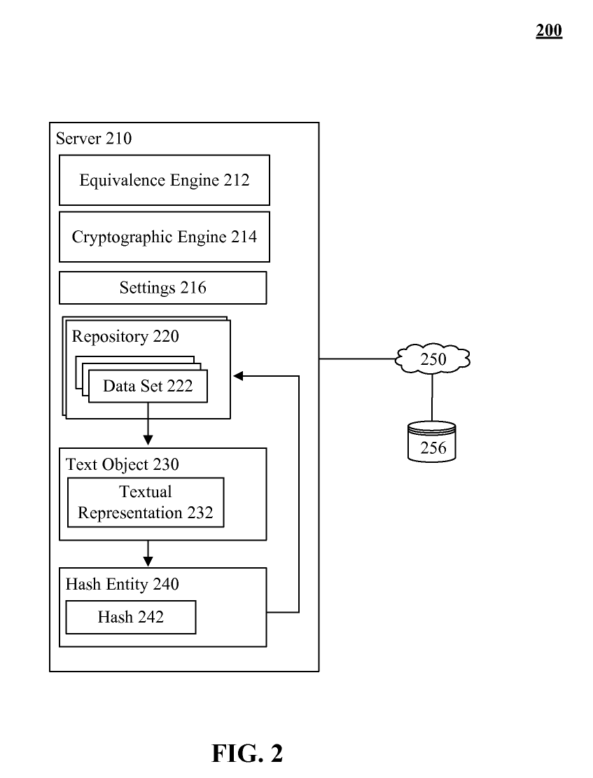

FIG. 2 is a schematic diagram illustrating a system 200 for determining equivalence of large state repositories utilizing the composition of an injective function and a cryptographic hash function in accordance with an embodiment of the inventive arrangements disclosed herein. System 200 can facilitate method 100 to be performed. In system 200, a server 210 can employ hash entity 240 to rapidly determine the equivalence of one or more data sets (e.g., data set 222) associated with one or more repositories (e.g., repository 220). As used herein, equivalence determination can include establishing the likelihood that N repositories are identical in state and/or form. Equivalence determination can be performed on data sets from multiple repositories, data set 222, portions of the data set 222, and the like. For instance, data set 222 can include a tree structured data which can require equivalence determination with another tree structured data associated with another repository prior to synchronization of the two data sets.

Server 210 can be a hardware/software component configured to determine the equivalence of N data sets and/or repositories. Server 210 can include, but is not limited to, equivalence engine 212, cryptographic engine 214, settings 216, repository 220, text object 230, hash entity 240, and the like. Server 210 can be one or more components of a software change management environment. In one instance, server 210 can be an IBM RATIONAL CLEARCASE server.

Equivalence engine 212 can be a hardware/software component able to identify and determine the equivalence of N data sets 222 and/or repositories 220. Engine 212 can convey and/or receive artifacts associated with equivalence determination including, but not limited to, data associated with equivalence requests (e.g., remote procedure call), information associated with equivalence results, and the like. Engine 212 can be configured (e.g., via settings 216) to handle traditional and/or proprietary data formats associated with data set 222. In one embodiment, equivalence engine 212 functionality can be a Web-enabled service. Engine 212 can be used to generate text object 230 from data set 222. In one instance, engine 212 can employ an injective function to create text object 230. In the instance, the injective function will be a function that maps one element within an element domain with one element of a co-domain. When text object 230, object 230 can be conveyed to cryptographic engine 214.

Cryptographic engine 214 can be a hardware/software component capable of generating a secure hash from text object 230. Engine 214 can generate secure hash entity 240 utilizing one or more cryptographic techniques including, but not limited to, Secure Hash Algorithm-1 (SHA-1), SHA-2, Message Digest Algorithm (MD-5), and the like. In one instance, engine 214 can utilize proprietary cryptographic algorithms to generate hash entity 240. In one instance, engine 214 can utilize one or more traditional cryptographic application programming interfaces (API) to establish hash entity 240.

Settings 216 can be one or more configuration parameters for controlling engine 212, 214. Settings 216 can include, but is not limited to, equivalence determination frequency, repository selection, and the like. In one instance, settings 216 can be used to configure textual representation 232 encoding and/or hash 242 type. In another instance, settings 216 can be used to determine degrees of difference between two or more data sets. For example, based on the result of equivalence determination, settings 216 can be used to establish user friendly messages indicating the similarity between data sets.

Repository 220 can be a hardware/software component for storing data set 222 which can comprise of one or more traditional and/or proprietary standards. Standards can include, storage formats, operating systems, and the like. Storage formats can include, but is not limited to, files, relational databases, and the like. Operating systems associated with repository 220 can be, but is not limited to, IBM z/OS, Unix, Linux, and the like. In one instance, repository 220 can be a software repository associated with a change management system. For instance, repository 220 can be a source code repository associated with a SUBVERSION revision control software.

Data set 222 can be one or more portions of computing data which can comprise of form and state information. Data set 222 can be a rooted tree structure, a free structure, a directed acyclic graph structure, and the like. For example, data set 222 can be a directory structure within a client computing environment. In one instance, data set 222 can be stored within a repository 220 of a software configuration management server 210. In another instance, data set 222 can be a directory structure not under change management. Data set 222 can include, but is not limited to, text data, multimedia data, binary data, and the like. Data set 222 can be formatted in numerous ways according to repository 220 operating system, repository 220 settings, server 210 configuration parameters and the like.

Text object 230 can be one or more text encoded entities associated with data set 222. Object 230 can comprise of, but is not limited to, textual representation 232, metadata (not shown), and the like. Textual representation can be a canonical text representation of state and/or form information for each node of data set 222 under equivalence determination. In one instance, textual representation 232 can be a canonical text representation of data set 222 resulting from an injective function being performed on data set 222. Metadata can include, but is not limited to, repository identification information, data set 222 identification information, date/timestamp, service information, request information, and the like.

Hash entity 240 can be a cryptographically generated entity for establishing equivalence determination of a data set 222 with another data set. Entity 240 can comprise of, but is not limited, to hash 242, hash metadata (not shown), and the like. Hash entity 240 can vary in length depending on engine 214 settings, SCM server 210 settings, and the like. In one instance, hash entity 240 can be a 32 byte SHA-256 cryptographic hash. Metadata can include, but is not limited to, repository identification information, data set 222 identification information, date/timestamp, service information, request information, and the like. It should be appreciated, hash entity 240 size is appreciably smaller than text object 230 and data set 222, enabling hash entity 240 to be communicated rapidly between different repositories during equivalence determination.

Once hash entity 240 is generated, entity 240 can be conveyed to a repository for equivalence determination. For example, hash entity 240 associated with data set 222 of repository 220 can be communicated to another repository to determine equivalence of two data sets. In one instance, the hash entity 240 and/or hash 242 can be conveyed over a network, including, but not limited to, bus, public networks, private networks, virtual private networks, and the like. In one embodiment, network can be a public network such as the Internet. In one instance, hash 242 value can be communicated in response to an equivalence determination request.

It should be appreciated that use of hash entity 240 to perform equivalence determination can simplify complexities involved in traditional equivalence determination associated with cross vendor repository synchronization. That is, comparing hash 242 values can be a trivial operation able to be performed within any traditional repository software and/or operating system.

In one embodiment, server 210 can be implemented across a distributed space, where the repositories 220 are remotely located from each other. In one embodiment server 210 can be connected to a network 250 as can one or more data stores 256, which are synchronized with one or more repository 220.

In one embodiment, comparisons between tree structured repositories 220 can be conducted on a sub-repository basis. That is, a folder, subfolder, or other subset of a repository 220 can be compared against a corresponding folder, subfolder, or other subset of an equivalent repository 220 by performing method 100 (e.g., generating a text file via a injective function, and generating hash functions from the text file, which are compared).

In one embodiment, an initial hash value can be generated and compared for each repository being compared. When the hash values are not equivalent, then hash values can be generated for each subfolder of each repository, so that they can be compared. This approach can help to quickly determine a potion of a tree structured repository that is different from a portion of a corresponding repository. Data synchronization actions can then be performed against only the subset of the repository that fails to correspond.

In one embodiment, functionality disclosed by system 200 can be encapsulated within a middleware software. For example, system 200 can be a component of an IBM WEBSPHERE middleware. Local generation of hash keys can occur through distributable plug-ins.

In one contemplated embodiment, the drive comparison technique (e.g., method 100) disclosed herein can be implemented within hardware of a physical hard drive or other tangible storage medium able that stores tree structured digitally encoded information. For example, two hard drives set up in a mirrored RAID configuration can create hashes and use them to compare the two hard drives to ensure they contain equivalent data. This technique also applies to mirroring two drives across any distances.

Drawings presented herein are for illustrative purposes and should not be construed to limit the invention in any regard. System 200 can permit equivalence determination of data sets within a singular repository, equivalence determination of data sets across multiple repositories, and the like. Further, functionality of system 200 can be employed to improve traditional peer-to-peer services such as file sharing services (e.g., photo sharing) where significantly large amounts of repositories are required to be synchronized. For example, system 200 functionality can be employed to enhance common file synchronization scenarios associated with SUGARSYNC, POWERFOLDERS, and the like.

The flowchart and block diagrams in the FIGS. 1-2 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for comparing a plurality of different data repositories to each other comprising:
executing an injective function against two different data repositories to generate a textual state representation for each of the different data repositories, wherein the injective function is a function that preserves distinctness of each element within the element domain, wherein the distinctness is a one-to-one mapping of each element within the element domain to one element of a co-domain;
executing a hash function for each of the different textual state representations to generate a corresponding hash number, which is smaller in size than the textual state representation to which it corresponds;
comparing the hash numbers to each other,
when results from the comparing indicate the hash numbers are equivalent, determining that the two different data repositories are equivalent to each other; and
when results from the comparing indicate the hash numbers are not equivalent, determining that the two different data repositories are not equivalent to each other.

2. The method of claim 1, wherein each of the at least two different data repositories are tree-structured state repositories comprising a plurality of nodes, each of the nodes comprising at least one name and at least one state item, wherein a node of one of the different data repositories is equivalent to a node of another of the different data repositories only when the corresponding names and state items are identical, and wherein when each node of different data repositories is equivalent to each node of another of the different data repositories, the generated textual state representations for the data repositories must be identical.

3. The method of claim 1, wherein the hash functions are secure hash (SHA) functions.

4. The method of claim 1, wherein the at least two different repositories are remotely located from each other, said method further comprising:
conveying at least one of the hash numbers over a network without conveying either a corresponding textual state representation or content of a corresponding data repository over the network before the comparing.

5. The method of claim 4, wherein the executing of the injective functions and the executing of the hash functions occur concurrently at different locations for each of the data repositories to concurrently generate the different textual state representations and the hash numbers for the respective data repositories.

6. The method of claim 1, wherein each of the hash numbers is at least one thousand times smaller than the corresponding textual state representation.

7. The method of claim 1, wherein the method results in over a thousand fold decrease in time to compare the different data repositories as referenced against a direct node-by-node comparison technique.

8. The method of claim 1, wherein the at least two different data repositories comprise at least three different data repositories.

9. The method of claim 1, wherein the at least two different data repositories comprise N repositions, wherein an increase in efficiency gained by using the method increases geometrically as N increases, wherein the increase in efficiency is referenced against a direct node-by-node comparison technique.

10. The method of claim 1, wherein at least one of the two different repositories is a repository of files that is to remain synchronized with another of the at least two different repositories that is remotely located from the one repository, said method comprising:
performing a synchronization action between the one repositories and the another repository only when the data repositories are determined to be not equivalent to each other due to the corresponding hash numbers being determined as being not equivalent to each other.

11. The method of claim 1, wherein each of the at least two different repositories are relational database repositories comprising data stored according to relational database standards.

12. The method of claim 1, wherein each of the at least two different repositories are file management repositories comprising a set of files organized within a hierarchy of folders and stored according to file management standards.

13. The method of claim 1, wherein different storage formats and standards exist for the at least two different repositories being compared by the method.

14. The method of claim 1, wherein each of the different repositories are tree-structured, wherein at least one of the different repositories has a first structure and another of the different repositories being compared has a second structure, wherein the first structure and the second structure are different structures selected from a set of structures consisting of rooted tree structure, a free tree structure, and a directed acyclic graph structure.

15. A computer program product comprising a computer readable storage medium having computer usable program code embodied therewith, the computer usable program code comprising:
computer usable program code stored in a tangible storage medium, when said computer usable program code is executed by a processor it is operable to execute an injective function against two different data repositories to generate a textual state representation for each of the different data repositories, wherein the injective function is a function that preserves distinctness of each element within the element domain, wherein the distinctness is a one-to-one mapping of each element within the element domain to one element of a co-domain;
computer usable program code stored in a tangible storage medium, when said computer usable program code is executed by a processor it is operable to execute a hash function for each of the different textual state representations to generate a corresponding hash number, which is more than one hundred times smaller in size than the textual state representation to which it corresponds;
computer usable program code stored in a tangible storage medium, when said computer usable program code is executed by a processor it is operable to compare the hash numbers to each other,
computer usable program code stored in a tangible storage medium, when said computer usable program code is executed by a processor it is operable to, when results from the comparing indicate the hash numbers are equivalent, determine that the two different data repositories are equivalent to each other; and
computer usable program code stored in a tangible storage medium, when said computer usable program code is executed by a processor it is operable to, when results from the comparing indicate the hash numbers are not equivalent, determine that the two different data repositories are not equivalent to each other.

16. The computer program product of claim 15, wherein each of the at least two different data repositories are tree-structured state repositories comprising a plurality of nodes, each of the nodes comprising at least one name and at least one state item, wherein a node of one of the different data repositories is equivalent to a node of another of the different data repositories only when the corresponding names and state items are identical, and wherein when each node of different data repositories is equivalent to each node of another of the different data repositories, the generated textual state representations for the data repositories must be identical.

17. The computer program product of claim 15, wherein the at least two different repositories are remotely located from each other, said method further comprising:
computer usable program code stored in a tangible storage medium, when said computer usable program code is executed by a processor it is operable to convey at least one of the hash numbers over a network without conveying either a corresponding textual state representation or content of a corresponding data repository over the network before the comparing.

18. The computer program product of claim 15, wherein the computer program product results in over a thousand fold decrease in time to compare the different data repositories as referenced against a direct node-by-node comparison technique.

19. A system comprising:
a processor;
a volatile memory;
a bus connecting said processor, non-volatile memory, and volatile memory to each other, wherein the volatile memory comprises computer usable program code execute-able by said processor, said computer usable program code comprising:
an equivalency engine operable to compare at least two tree structured data stores to each other, wherein said equivalency engine generates a textual state representation for each of the at least two tree structured data stores, wherein said textual state representation injectively maps to a corresponding tree structured data store, wherein said equivalency engine generates a hash number for each of the textual state representations and compares the hash numbers to compare the at least two tree structured data stores to each other.

20. The system of claim 19, wherein each of the at least two different data repositories are tree-structured state repositories comprising a plurality of nodes, each of the nodes comprising at least one name and at least one state item, wherein a node of one of the different data repositories is equivalent to a node of another of the different data repositories only when the corresponding names and state items are identical, and wherein when each node of different data repositories is equivalent to each node of another of the different data repositories, the generated textual state representations for the data repositories must be identical.
